(19) United States
(12) Patent Application Publication
(10) Pub. No.: US 2026/0217098 A1
(43) Pub. Date: Jul. 30, 2026

(54) ROLL PICK-UP TRUCK TONNEAU COVER

(71) Applicant: Wenzhou L-Ray Auto Parts Co.,Ltd., Wenzhou (CN)

(72) Inventors: Dingqi Ma, Wenzhou (CN); Shangyi Xie, Wenzhou (CN)

(21) Appl. No.: 19/069,706

(22) Filed: Mar. 4, 2025

(30) Foreign Application Priority Data
Jan. 26, 2025 (CN) 202510125450.1

(51) Int. Cl. B60J 10/90; B32B 3/06; B32B 15/08; B60J 10/34

(52) U.S. Cl. CPC B60J 10/90; B32B 3/06; B32B 15/08; B60J 10/345; B32B 2605/00

(57) ABSTRACT

The invention discloses a roll pick-up truck tonneau cover, relating to the technical field of automotive parts. The cover comprises a plurality of soft layers arranged in a discontinuous manner, each covering the rotational gap between two adjacent segmented panels to conceal the gap. Both side of the soft layers is connected to the respective clamping parts of the adjacent panels, ensuring that the soft layers remain in position to cover the rotational gap.

### BACKGROUND OF THE INVENTION

Present invention is relevant to technical field of automotive parts, especially a roll pick-up truck tonneau cover.

Pickup trucks, as a common type of vehicle, offer car-like comfort without losing power. Due to its strong cargo carrying and adaptability to poor road conditions and its strong overall performance, pickup trucks have become one of the most common off-road vehicles nowadays. In order to adapt to more diverse environments, most existing pickups require the installation of a truck cover. In the existing technology, some pick-up truck use a roll-top structure for the soft top. The waterproof structure typically uses a continuously arranged waterproof layer, with a roll cover assembly covering the truck bed. After long exposure to wind and sun, and with the roll cover assembly bending the leather when rolled up, the leather is prone to bulge or even detach extensively from the door leaf after use, leading to waterproof failure. Additionally, since it uses a continuously arranged waterproof layer, if any part is damaged, the entire waterproof layer needs to be replaced.

### BRIEF SUMMARY OF THE INVENTION

The embodiments of the present invention provide a roll pickup truck tonneau cover to at least address the technical problem of the continuous waterproof layer bending the waterproof leather when rolled up, causing the leather to bulge and detach, as well as localized damage and the need for overall replacement.

In order to solve the above problems of the existing technology, the technical solution adopted in the invention is as follows:
A roll pick-up truck tonneau cover, comprising a cover, the cover comprises:
An intermediate panel with a lay-flat state and a rolled-up state, formed by a plurality of segmented panels rotatably connected. One of the segmented panels can rotate relative to an adjacent segmented panel, and a rotational gap is provided at the transition position between two adjacent segmented panels. At least one edge of each segmented panel is provided with a clamping part.
A plurality of soft layers, arranged in a discontinuous manner, each covering the rotational gap between two adjacent segmented panels to seal the rotational gap.

Both side of each soft layer is connected to the two adjacent clamping parts respectively, ensuring the covered state of the soft layer over the rotational gap.

The beneficial effects are as follows: the roll pick-up truck tonneau cover provided by the embodiment of the present invention arranges the soft layer on the adjacent rotation gaps in a discontinuous manner, not only ensures waterproofing but also provides excellent extensibility, avoiding excessive bending of the entire waterproof layer after rolling, which could cause the leather prone to bulge or even detach extensively from the door leaf, leading to waterproof failure. Additionally, by adopting a discontinuous arranged waterproof layer, if any part is damaged, only the individual segment of the waterproof layer needs to be replaced, reducing maintenance costs.

Further, each segmented panel comprises an upper layer and a lower layer arranged vertically. The upper layer may be metal or plastic, the lower layer may also be metal or plastic. A Fastener is provided between at least two of the three components: the upper layer, the lower layer, and the soft layer. The purpose of this design is to fix the upper layer, lower layer, and soft layer together to improve waterproofing.

Further, the segmented panel comprises a protrusion and a recess, positioned at the center of the upper layer facing the lower layer or at the center of the lower layer facing the upper layer. Wherein the protrusion is matched with the recess to restrict and maintain the relative position between the upper layer and the lower layer. The purpose of this design is to restrict the relative position between the upper layer and the lower layer, preventing misalignment or displacement.

Further, a partial gap is provided at the edge position between the upper layer and the lower layer. One side of the soft layer is clamped into the partial gap at the edge of one segmented panel, while the other side extends over the transition position of the adjacent segmented panel and is clamped into the partial gap at the edge of the adjacent segmented panel, thereby covering the rotational gap between the two adjacent segmented panels. The purpose of this design is to fix both sides of the soft layer at the gap and have the central portion cover the rotating gap, ensuring the waterproofing effect.

Further, the clamping part is set within the partial gap and includes:
At least one protrusion, positioned on the side of the upper layer facing the lower layer or on the side of the lower layer facing the upper layer.

At least one indentation, positioned on the side of the lower layer facing the upper layer or on the side of the upper layer facing the lower layer.

Wherein:
The protrusion of the upper layer may or may not correspond to the indentation of the lower layer.
Or
The indentation of the upper layer may or may not correspond to the protrusion of the lower layer. Or
The soft layer may or may not be clamped between the protrusion of the upper layer and the lower layer. Or
The soft layer may or may not be clamped between the protrusion of the lower layer and the upper layer.

The purpose of this design is to specifically provide the location and structural form of one embodiment of the clamping part, in order to position the soft layer.

Further, the clamping part includes at least two accommodating grooves and two clamping members. One of the accommodating grooves is provided at the edge of one upper layer or lower layer, while the other is provided at the edge of the adjacent upper layer or lower layer. The two accommodating grooves are arranged opposite each other.

At least two clamping members are positioned and restricted within the two accommodating grooves. One side of the soft layer is fixed to one clamping member, while the other side is fixed to the adjacent clamping member, ensuring that the soft layer covers the rotational gap between two adjacent segmented panels. The purpose of this design is to specifically provide the location and structural form of another embodiment of the clamping part, in order to position the soft layer, ensuring that the soft layer covers and seals the rotating gap.

Further, the clamping member may be a metal strip or plastic strip sewn onto the edge of the soft layer. The purpose of this design is to specifically provide the location and structural form of the clamping member.

Further it comprises:
A rear panel, rotatably connected to one side of the intermediate panel.
A front panel, rotatably connected to the other side of the intermediate panel.
Two guide rails, fixed to the two sides of the pickup truck body by clamps.

Further, each segmented panel, front panel, and rear panel has support members installed at both ends, adjacent support members are connected rotationally or non-rotationally. A first Velcro strip is provided on the side of the support member near the guide rail through a first fastener, the first Velcro strip is featured in either a loop or hook surface. Inside the guide rail, a plastic plate is inserted and secured with fasteners. The side of the plastic plate near the support member is provided with a second Velcro strip, featuring either a hook or loop surface. The first Velcro strip is bonded with the second Velcro strip. The purpose of this design is to bond the tonneau cover and the guide rails together using the adhesion between the Velcro strips. This not only improves the fixation but also enhances the sealing performance.

Further, the first fastener is a U-shaped staple, the plastic plate is either sewn with or integrally formed with the second Velcro strip.

Further, an elastic strip is provided on the inner side of the guide rail. The purpose of this design is to press the bottom surface of the tonneau cover against and compress it above the elastic strip, enhancing the sealing between the tonneau cover and the guide rails, thereby further improving the waterproof performance.

Further, the plastic plate is provided with a plurality of drainage holes along its length.

The drainage component is installed at the front or rear end of the guide rail, the inlet of the drainage component is connected to the drainage holes. The outlet of the drainage component is connected to a drainage pipe. The purpose of this design is to direct the water on both sides of the tonneau cover into the guide rails through the drainage holes. Then, the water is channeled to the input end of the drainage component, which, through the output end, discharges the water through the drainage pipe.

Further, it comprises a sealing strip, which is an elastic component. The bottom surface of the sealing strip is bonded to the upper layer, support member, front panel, or rear panel by glue, and the sealing strip extends through the support member. The purpose of this design is to use the sealing strip to cover the rotational gaps, thereby enhancing the sealing and waterproofing effect.

Further, the upper layer, lower layer, front panel, or rear panel is provided with screw holes. The contact surface between the support member and the upper layer, lower layer, front panel, or rear panel is sealed with glue for waterproofing. The support member is connected to the upper layer, lower layer, front panel, or rear panel by fasteners. The purpose of this design is to improve the tightness and sealing at each connection point.

Further, the sealing strip comprises a covering section and a T-shaped section integrally formed with the covering section. The top of each support member is provided with a clamp slot, the clamp slots of multiple support members are connected in series to form a discontinuous positioning groove. The T-shaped section is inserted into the positioning groove to ensure that the sealing strip remains in constant contact with the support member, while the covering section covers and seals the gap between the support member and the segmented panel. The purpose of this design is that the covering portion of the sealing strip serves a shielding function, while the integrally formed T-shaped portion functions to securely fix the covering portion in place.

Further, the front face of the front panel is connected to a first fixing buckle by fasteners on both sides along its width direction. The rear face of the front panel is provided with fixing rods positioned on both sides along its width direction, the fixing rods are connected to second fixing buckles through first webbing. When the cover is in rolled-up state, the second fixing buckle is inserted into and locked with the first fixing buckle, while the first webbing hold and restrict the cover in its rolled-up position. The purpose of this design is to fix the rolled-up tonneau cover in place to maintain its rolled-up state.

Further, it comprises a fixing slider, a second fastener and an anti-loosening component, the fixing slider is slidably connected to the guide rail. one end of the second fastener is positioned inside a first sliding groove on the back of the front panel, while the other end extends out of the sliding groove, passes through the fixed slider, and is equipped with a locking component, the anti-loosening component is provided between the locking component and the second fastener. The purpose of this design is to fix the front panel and the guide rail together, making the structure more compact and stable. The anti-loosening component helps prevent any loosening between the locking component and the second fastener.

Further, it comprises a second webbing, with one end provided with a fourth fixing buckle and the other end secured between the second fastener and the locking component. The front panel is provided with a third fixing buckle installed on both sides along its width direction using fasteners. The third fixing buckle and the fourth fixing buckle are locked together. The purpose of this design is to secure the rolled-up cover in place, ensuring its rolled-up state.

Further, the rear panel is provided with extendable and retractable locking latch on both sides along its width direction. When the locking latch is in the extended state, the rear panel is locked with the guide rail. When the locking latch is in the retracted state, the rear panel is in an unlocked state relative to the guide rail.

Further, it comprises:
A lock casing, positioned in a groove on the back of the rear panel, the lock casing is provided with a sliding slot, a pull-rod slot, and a wire slot, the sliding slot and the pull-rod slot are interconnected with the wire slot.
The locking latch is slidably connected with the sliding slot.
A pull rod with a rod section and a head section, where the head section is located inside the pull-rod slot, one end of the rod section is connected to the head section, while the other end extends into the sliding slot, is fitted with a spring, and, after passing through the spring, is connected to the locking latch through a pin.
A fixing part is secured above the wire slot by a third fastener, the third fastener is provided with a window through which the webbing is positioned.
A pull wire, which extends into the wire slot, passes through the webbing, and is secured to the head section of the pull rod by a fourth fastener.

When the webbing is pulled in the direction away from the fixing part, the webbing pulls the pull rod towards the wire slot. The pull rod through the pin, drives the locking catch to slide along the slide groove and compresses the spring, causing the spring undergoes elastic deformation, thereby retracting the locking latch.

Further, the back of the cover is provided with at least one elastic component, which is connected to the cover by a fifth fastener, the fifth fastener is embedded in the elastic component. The purpose of this design is to use the elastic component as a buffer to prevent the lock latch or the fastening components on the back from wearing down the surface of the roll cover.

### BRIEF DESCRIPTION OF THE DRAWINGS

FIG. 1 is a diagram of the roll-up cover in its flat state according to the embodiment of the present invention.

FIG. 2 is a diagram of the roll-up cover in its rolled-up state according to the embodiment of the present invention.

FIG. 3 is a diagram of the intermediate panel in its flat state according to the embodiment of the present invention.

FIG. 4 is a side view of the intermediate panel according to the embodiment of the present invention.

FIG. 5 is an enlarge view of part A in FIG. 4 (a schematic diagram of one embodiment of the soft layer arrangement).

FIG. 6 is another schematic diagram of the soft layer arrangement according to the present invention.

FIG. 7 is an enlarge view of part B in FIG. 6.

FIG. 8 is a back view of the intermediate panel.

FIG. 9 is a front view of the guide rail.

FIG. 10 is a partial exploded view of the roll-up cover.

FIG. 11 is an enlarge view of part C in FIG. 10.

FIG. 12 is a first perspective schematic diagram of the back of the roll-up cover.

FIG. 13 is an enlarge view of part D in FIG. 12.

FIG. 14 is another perspective schematic diagram of the roll-up cover.

FIG. 15 is an enlarge view of part E in FIG. 14.

FIG. 16 is a second perspective schematic diagram of the back of the roll-up cover.

FIG. 17 is an enlarge view of part F in FIG. 16.

FIG. 18 is an enlarge view of part G in FIG. 16.

FIG. 19 is a partial exploded view of the locking mechanism of the roll-up cover.

FIG. 20 is a third perspective schematic diagram of the back of the roll-up cover.

FIG. 21 is an enlarge view of part H in FIG. 20.

FIG. 22 is another perspective schematic diagram of the roll-up cover.

FIG. 23 is an enlarge view of part I in FIG. 22.

FIG. 24 is a fourth perspective schematic diagram of the back of the roll-up cover.

FIG. 25 is an enlarge view of part J in FIG. 24.

FIG. 26 is a schematic diagram of the guide rail.

FIG. 27 is an enlarge view of part K in FIG. 26.

FIG. 28 is a schematic diagram of the support component.

FIG. 29 is a partial exploded view of the roll-up cover.

FIG. 30 is an enlarge view of part L in FIG. 29.

FIG. 31 is an enlarge view of part M in FIG. 29.

### DETAILED DESCRIPTION OF THE INVENTION

The following instruction further explains the invention's concrete implementation method.

In the description in present invention, it is to be understood that the orientation or positional relationships indicated by the terms “top”, “bottom”, “inside”, “outside”, “top”, “bottom”, “top”, “bottom”, “inside”, “bottom”, “inside”, “outside”, etc. are based on the orientation or positional relationships shown in the accompanying drawings, which serve only to facilitate the description in present invention and simplify the description, and are not to be construed as limiting the present invention in any way as they indicate or imply that the device or element referred to must be constructed and operated with a specific orientation or be constructed and operated in a specific orientation.

In the description of the invention, it should also be noted that, unless otherwise expressly specified and limited, the terms “arranged,” “installed,” “connected,” and “combined” should be understood in a broad sense. for example, it may be a fixing connecting, it can also be a detachable connecting or an integral connecting. it can be a mechanical connecting or an electrical connecting. it can be a direct connecting or an indirect connecting through an intermediate media. And it can be internal connecting within two components. For those of ordinary skill in this field, specific meanings of the above terms in the present invention can be understood in specific situations.

In this invention, unless otherwise stated, directional terms such as “axial,” “circumferential,” and “radial” generally refer to directions defined relative to the rotational axis of the rotor in the drive motor. “Inner” and “outer” refer to the inside and outside of the respective component profiles. The use of terms such as “first,” “second,” etc., is intended to distinguish between different components and does not imply any sequential or hierarchical importance. Furthermore, in the following description, when referring to the drawings, the same reference numerals in different drawings indicate the same or similar elements, unless otherwise explained.

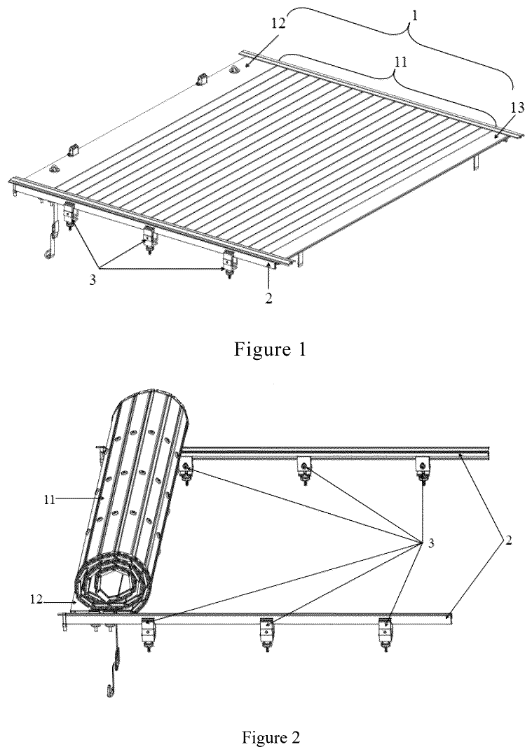

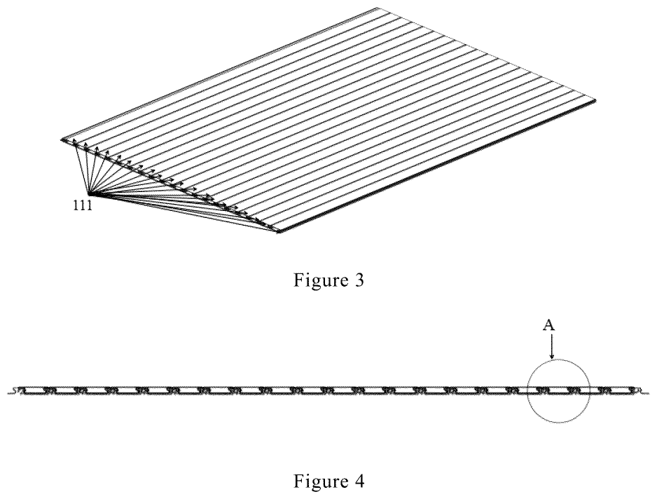

The present invention discloses a roll pick-up truck tonneau cover, see FIG. 1 it comprises a cover 1, the cover 1 comprises: an intermediate panel 11 and a plurality of soft layers 14. See FIGS. 2 and 3, the intermediate panel 11 is provided with a lay-flat state and a rolled-up state, formed by a plurality of segmented panels 111 rotatably connected. One of the segmented panels 111 can rotate relative to an adjacent segmented panel 111, and a rotational gap is provided at the transition position between two adjacent segmented panels 111. At least one edge of each segmented panel 111 is provided with a clamping part. A plurality of soft layers 14 is arranged in a discontinuous manner, each covering the rotational gap between two adjacent segmented panels 111 to seal the rotational gap. Wherein, both side of each soft layer 14 is connected to the two adjacent clamping parts respectively, ensuring the covered state of the soft layer 14 over the rotational gap. The clamping part refers to the fixing or positioning structure for the soft layer.

It should be noted that the soft layer mentioned above can be made of rubber, PVC mesh fabric, leather, metal, plastic, or a combination of one or more of these materials. The embodiment of the present application does not specifically limit the type of material used.

The roll pick-up truck tonneau cover provided by the embodiment of the present invention arranges the soft layer on the adjacent rotation gaps in a discontinuous manner, not only ensures waterproofing but also provides excellent extensibility, avoiding excessive bending of the entire waterproof layer after rolling, which could cause the leather prone to bulge or even detach extensively from the door leaf, leading to waterproof failure. Additionally, by adopting a discontinuous arranged waterproof layer, if any part is damaged, only the individual segment of the waterproof layer needs to be replaced, reducing maintenance costs.

Please refer to FIGS. 4 and 5 for a specific example of the segmented panel 111 mentioned above, each segmented panel 111 comprises an upper layer 112 and a lower layer 113 arranged vertically. A Fastener is provided between at least two of the three components: the upper layer 112, the lower layer 113, and the soft layer 14. The upper layer 112, lower layer 113, and soft layer 14 are fixed together to improve waterproofing. Each segmented panel may have the same or different widths. The upper layer 112 may be metal or plastic, the lower layer 113 may also be metal or plastic.

Refer to FIG. 5, to prevent misalignment or displacement, the segmented panel 111 further comprises a protrusion 114 and a recess 115, positioned at the center of the upper layer 112 facing the lower layer 113 or at the center of the lower layer 113 facing the upper layer 112. A recess 115 is provided at the center of the lower layer 113 facing the upper layer 112 or at the center of the upper layer 112 facing the lower layer 113. Wherein the protrusion 114 is matched with the recess 115 to restrict and maintain the relative position between the upper layer 112 and the lower layer 113. Thus to restrict the relative position between the upper layer 112 and the lower layer 113, preventing misalignment or displacement.

Please refer to FIG. 5 for a specific example of the arrangement of the soft layer 14, a partial gap is provided at the edge position between the upper layer 112 and the lower layer 113. One side of the soft layer 14 is clamped into the partial gap at the edge of one segmented panel 111, while the other side extends over the transition position of the adjacent segmented panel 111 and is clamped into the partial gap at the edge of the adjacent segmented panel 111, thereby covering the rotational gap between the two adjacent segmented panels 111. Fix both sides of the soft layer 14 at the gap and have the central portion cover the rotating gap, ensuring the waterproofing effect.

Alternatively, the segmented panel 111 may also be the upper layer 112 or a combination of the upper layer 112 and the lower layer 113.

Please refer to FIG. 5 for a specific example of the location and he specific structure of the clamping part. The clamping part is set within the partial gap, includes at least one protrusion 116, positioned on the side of the upper layer 112 facing the lower layer 113 or on the side of the lower layer 113 facing the upper layer 112. At least one indentation 117, positioned on the side of the lower layer 113 facing the upper layer 112 or on the side of the upper layer 112 facing the lower layer 113. Wherein, the protrusion 116 of the upper layer 112 may or may not correspond to the indentation 117 of the lower layer 113. Or the indentation 117 of the upper layer 112 may or may not correspond to the protrusion 116 of the lower layer 113. Or the soft layer 14 may or may not be clamped between the protrusion 116 of the upper layer 112 and the lower layer 113. Or the soft layer 14 may or may not be clamped between the protrusion 116 of the lower layer 113 and the upper layer 112. Specifically provide the location and structural form of one embodiment of the clamping part is to position the soft layer 14.

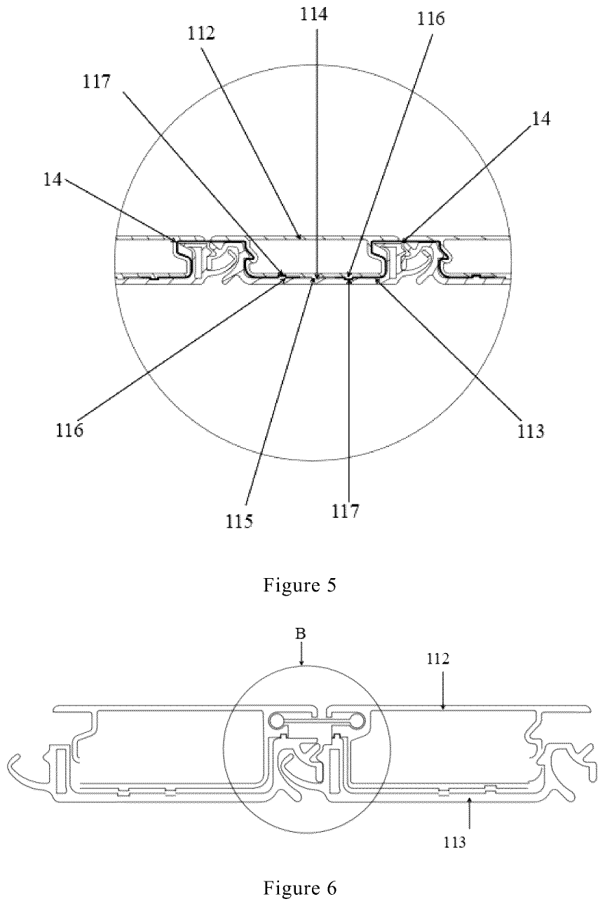

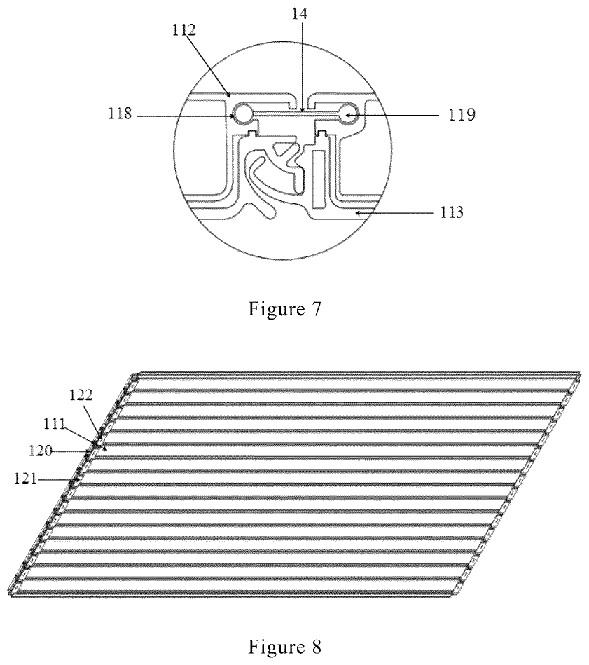

Please refer to FIGS. 6 and 7 for a specific example of another embodiment of the clamping part. The clamping part includes at least two accommodating grooves 118 and two clamping members 119. One of the two accommodating grooves 118 is provided at the edge of one upper layer 112 (or the edge of lower layer 113, FIGS. 6 and 7 provide an exemplary illustration with the configuration set at the edge of upper layer 112), while the other accommodating grooves 118 is provided at the edge of the adjacent upper layer 112 (or the edge of lower layer 113). The two accommodating grooves 118 are arranged opposite each other. At least two clamping members 119 are positioned and restricted within the two accommodating grooves 118. One side of the soft layer 14 is fixed to one clamping member 119, while the other side is fixed to the adjacent clamping member 119, ensuring that the soft layer 14 covers the rotational gap between two adjacent segmented panels 111. Specifically provide the location and structural form of another embodiment of the clamping part is to position the soft layer 14, ensuring that the soft layer 14 covers and seals the rotating gap. Further, the clamping member 119 may be a metal strip or plastic strip sewn onto the edge of the soft layer 14. The location and structural form of the clamping member 119 is specifically provided.

Please refer to FIGS. 1 and 2, it comprises a rear panel 13, a front panel 12 and guide rail 2, a rear panel 13 is rotatably connected to one side of the intermediate panel 11. A front panel 12 is rotatably connected to the other side of the intermediate panel 11. Two guide rails 2 are fixed to the two sides of the pickup truck body by clamps 3. The soft layer 14 may or may not be clamped with the front panel 12 or rear panel 13, and it covers the rotational gap.

Further refer to FIGS. 8, 9 and 28, each segmented panel 111, front panel 12, and rear panel 13 has support members 120 installed at both ends, adjacent support members 120 are connected rotationally or non-rotationally. A first Velcro strip 122 is provided on the side of the support member 120 near the guide rail 2 through a first fastener 121, the first Velcro strip 122 is featured in either a loop or hook surface. Inside the guide rail 2, a plastic plate 123 is inserted and secured with fasteners. The side of the plastic plate 123 near the support member 120 is provided with a second Velcro strip 124, the second Velcro strip 124 is featuring either a hook or loop surface. The first Velcro strip 122 is bonded with the second Velcro strip 123. By bonding the tonneau cover and the guide rails together using the adhesion between the Velcro strips. This not only improves the fixation but also enhances the sealing performance. The first fastener 121 is a U-shaped staple, the plastic plate 123 is either sewn with or integrally formed with the second Velcro strip 124. The first Velcro strip 122 is attached to the support member 120 and then fixed with a U-shaped staple. The support member 120 can be of plastic or metal.

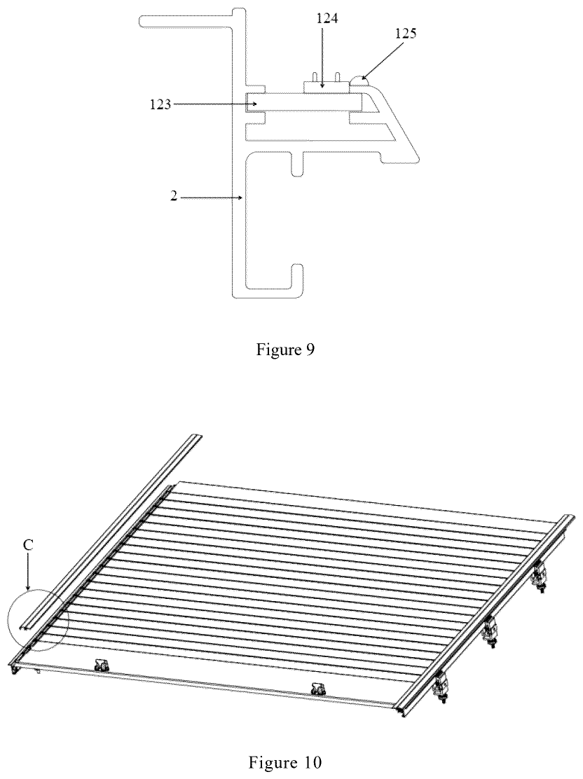

Further refer to FIG. 9, an elastic strip 125 is provided on the inner side of the guide rail 2. Press the bottom surface of the tonneau cover against and compress it above the elastic strip 125, enhancing the sealing between the tonneau cover and the guide rails 2, thereby further improving the waterproof performance.

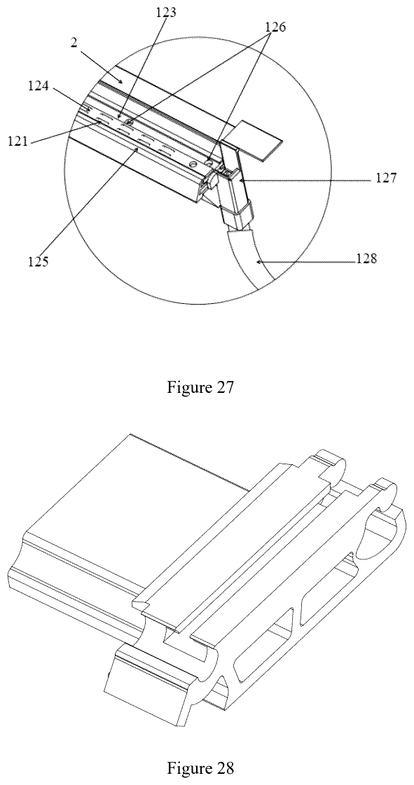

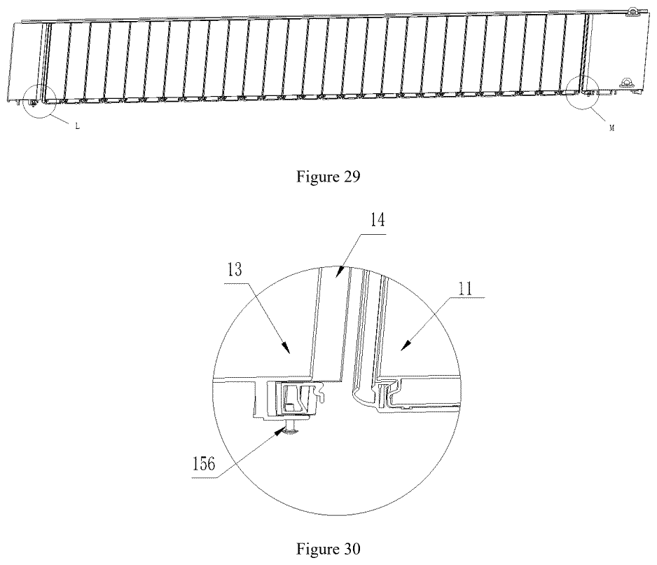

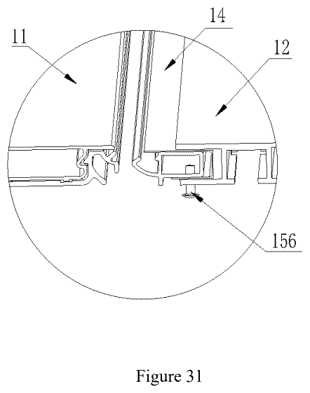

Further refer to FIGS. 26 and 27, the plastic plate 123 is provided with a plurality of drainage holes 126 along its length. The drainage component 127 is installed at the front or rear end of the guide rail 2, the inlet of the drainage component 127 is connected to the drainage holes 126. The outlet of the drainage component 127 is connected to a drainage pipe 128. The water on both sides of the tonneau cover is directed into the guide rail 2 through the drainage holes 126, then flows into the input end of the drainage component 127 from the guide rail 2. Finally, the water is discharged through the output end of the drainage component 127 through the drainage pipe 128.

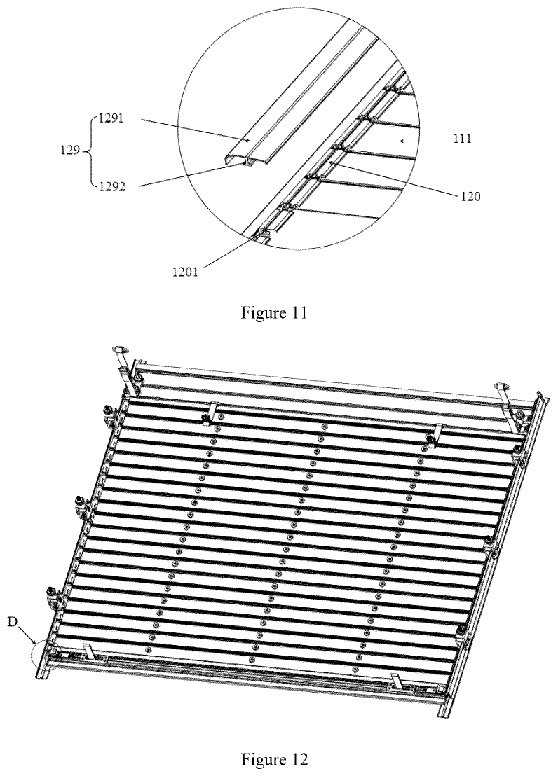

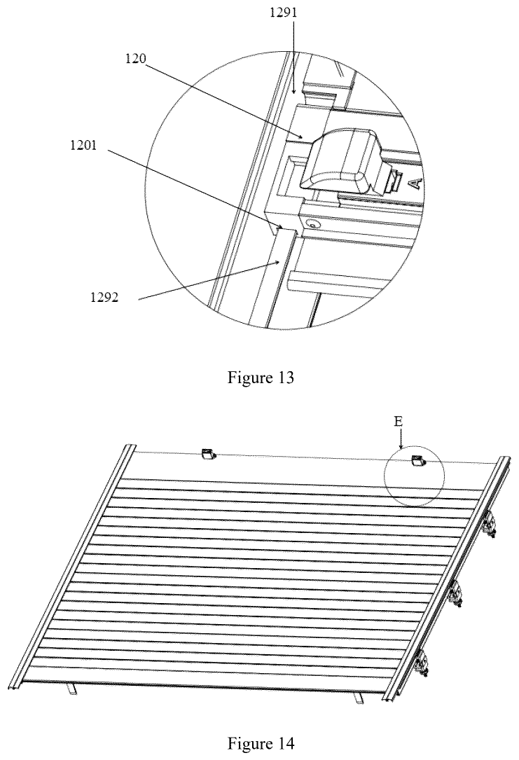

Further refer to FIGS. 10, 11, 12 and 13, it further comprises a sealing strip 129, which is an elastic component. The bottom surface of the sealing strip 129 is bonded to the upper layer 112, support member 120, front panel 12, or rear panel 13 by glue, and the sealing strip 129 extends through the support member 120. Using the sealing strip 129 to cover the rotational gaps enhances the sealing and waterproofing effect.

The upper layer 112, lower layer 113, front panel 12, or rear panel 13 is provided with screw holes. The contact surface between the support member 120 and the upper layer 112, lower layer 113, front panel 12, or rear panel 13 is sealed with glue for waterproofing. The support member 120 is connected to the upper layer 112, lower layer 113, front panel 12, or rear panel 13 by fasteners to improve the tightness and sealing at each connection point.

Further refer to FIG. 11, the sealing strip 129 comprises a covering section 1291 and a T-shaped section 1292 integrally formed with the covering section 1291. The top of each support member 120 is provided with a clamp slot 1201, the clamp slots 1201 of multiple support members 120 are connected in series to form a discontinuous positioning groove. The T-shaped section 1292 is inserted into the positioning groove to ensure that the sealing strip 129 remains in constant contact with the support member 120, while the covering section 1291 covers and seals the gap between the support member 120 and the segmented panel 111. The covering portion 1291 of the sealing strip 129 serves a shielding function, while the integrally formed T-shaped portion 1292 functions to securely fix the covering portion 1291 in place.

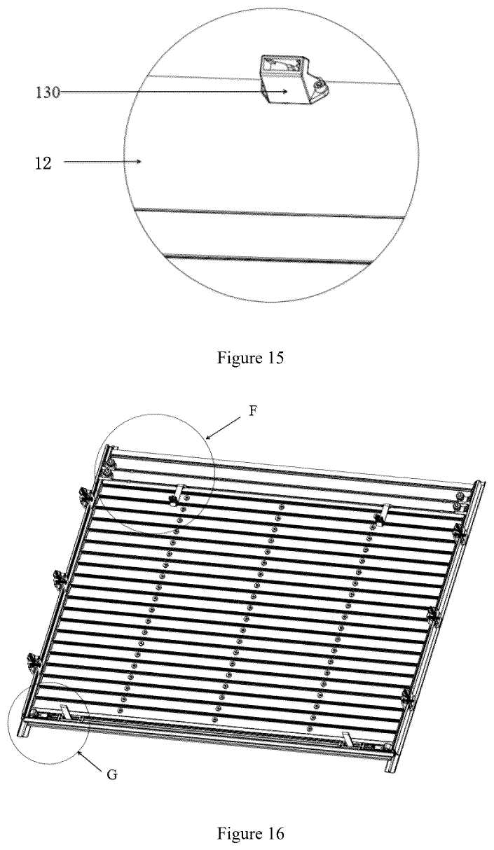

Further refer to FIGS. 14, 15, 16 and 17, the front face of the front panel 12 is connected to a first fixing buckle 130 by fasteners on both sides along its width direction. The rear face of the front panel 12 is provided with fixing rods 131 positioned on both sides along its width direction, the fixing rods 131 are connected to second fixing buckles 133 through first webbing 132. When the cover 1 is in rolled-up state, the second fixing buckle 133 is inserted into and locked with the first fixing buckle 130, while the first webbing 132 hold and restrict the cover 1 in its rolled-up position. The purpose of this design is to fix the rolled-up tonneau cover in place to maintain its rolled-up state.

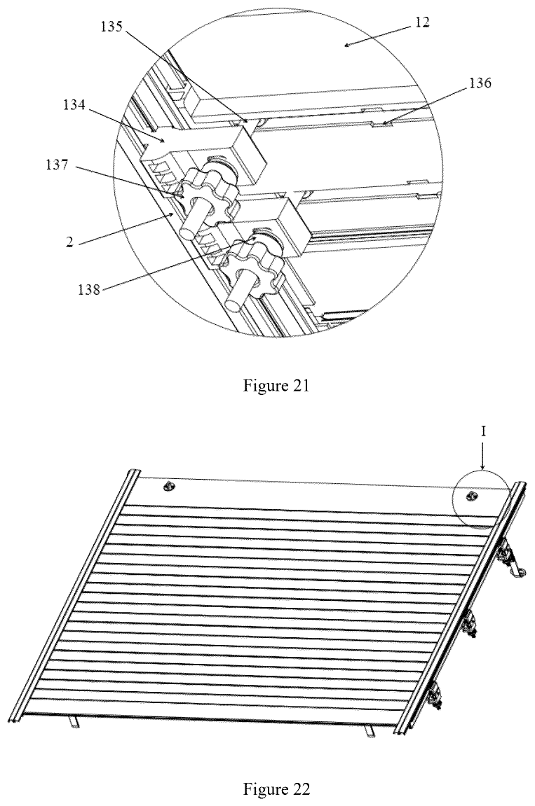

Further refer to FIGS. 20 and 21, it comprises a fixing slider 134, a second fastener 135 and an anti-loosening component 138, the fixing slider 138 is slidably connected to the guide rail 2. one end of the second fastener 135 is positioned inside a first sliding groove 136 on the back of the front panel 12, while the other end extends out of the sliding groove 136, passes through the fixed slider 134, and is provided with a locking component 137, the anti-loosening component 138 is provided between the locking component 137 and the second fastener 135.

Fixing the front panel 12 to the guide rail 2 makes the structure more compact, while the anti-loosening component 138 prevents any loosening between the locking component 137 and the second fastener 135.

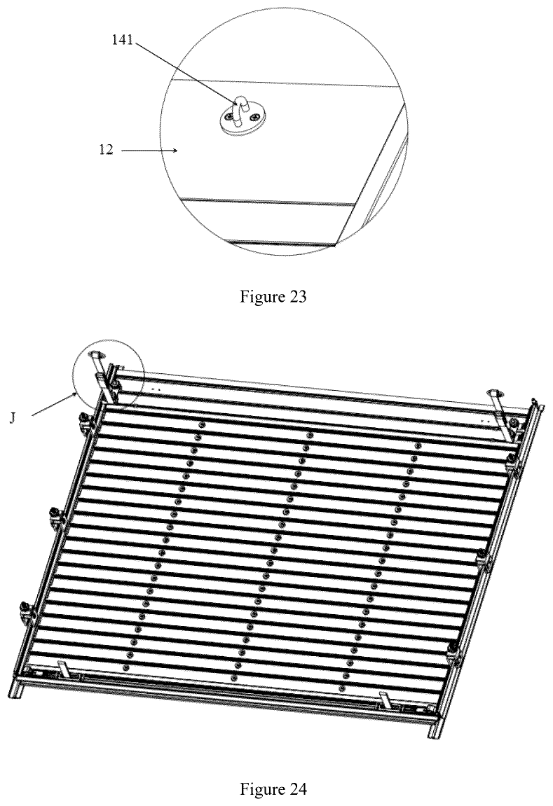

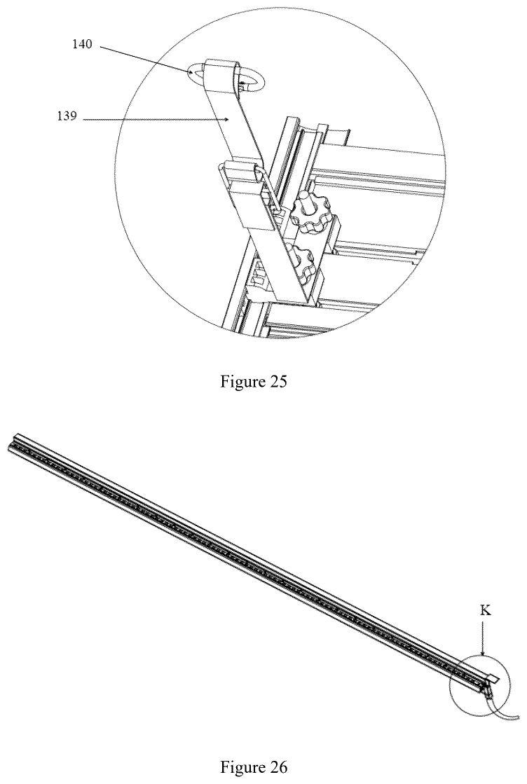

Further refer to FIGS. 22, 23, 24 and 24, it comprises a second webbing 139, with one end provided with a fourth fixing buckle 140 and the other end secured between the second fastener 135 and the locking component 137. The front panel 12 is provided with a third fixing buckle 141 installed on both sides along its width direction using fasteners. The third fixing buckle 141 and the fourth fixing buckle 140 are locked together. The purpose of this design is to secure the rolled-up cover in place, ensuring its rolled-up state.

Further refer to FIGS. 16 and 18, the rear panel 13 is provided with extendable and retractable locking latch 142 on both sides along its width direction. When the locking latch 142 is in the extended state, the rear panel 13 is locked with the guide rail 2. When the locking latch 142 is in the retracted state, the rear panel 13 is in an unlocked state relative to the guide rail 2.

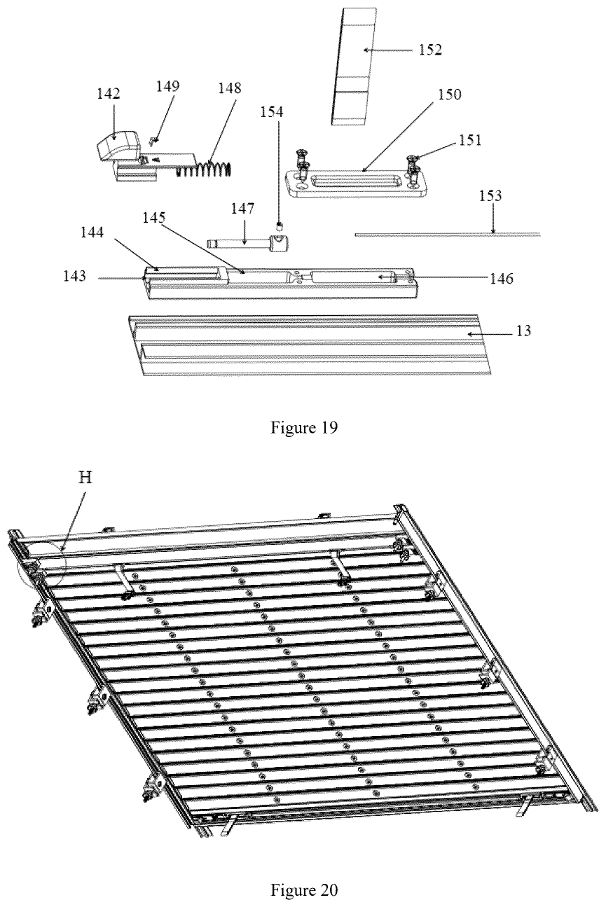

Further refer to FIG. 19, it further comprises a lock casing 143, positioned in a groove on the back of the rear panel 13, the lock casing 143 is provided with a sliding slot 144, a pull-rod slot 145, and a wire slot 146, the sliding slot 144 and the pull-rod slot 145 are interconnected with the wire slot 146. The locking latch 142 is slidably connected with the sliding slot 144. A pull rod 147 is provided with a rod section and a head section, where the head section is located inside the pull-rod slot 145, one end of the rod section is connected to the head section, while the other end extends into the sliding slot 144, is fitted with a spring 148, and, after passing through the spring 148, is connected to the locking latch 142 through a pin 149. The fixing part 150 is secured above the wire slot 146 by a third fastener 151, the third fastener 151 is provided with a window through which the webbing is positioned. The fixing part 150 and the lock casing 143 clamp the groove on the back, preventing the lock casing 143 from loosening or shifting as a whole during use. The window houses a webbing 152. A pull wire 153 extends into the wire slot 146, passes through the webbing 152, and is secured to the head section of the pull rod 147 by a fourth fastener 154. When the webbing 152 is pulled in the direction away from the fixing part 150, the webbing 152 pulls the pull rod 147 towards the wire slot 146 trough the pull wire 153.

The pull rod 147 through the pin 149, drives the locking latch 142 to slide along the slide groove 144 and compresses the spring 148, causing the spring 148 undergoes elastic deformation, thereby retracting the locking latch 142.

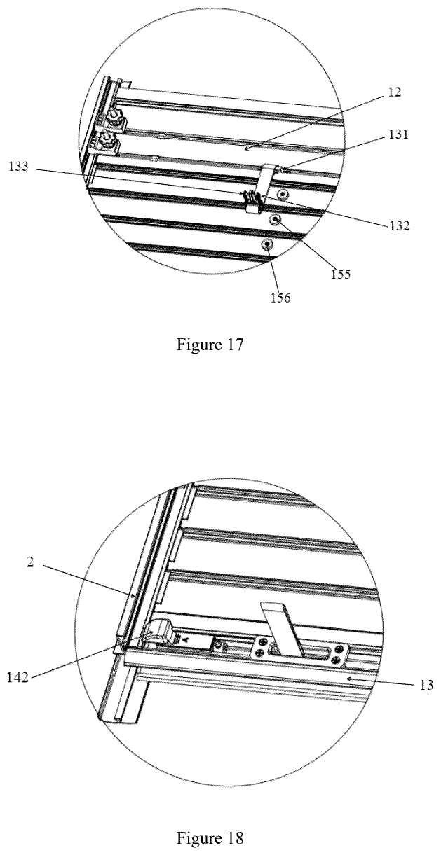

Further refer to FIG. 17, the back of the cover 1 is provided with at least one elastic component 155, which is connected to the cover 1 by a fifth fastener 156, the fifth fastener 156 is embedded in the elastic component 155. The elastic component 155 serves as a buffer to prevent the lock latch or the fasteners on the back from wearing down the surface of the roll cover.

In the description of this specification, specific features, structures, materials, or characteristics may be combined in any one or more embodiments or examples in a suitable manner.

In the description of this specification, specific features, structures, materials, or characteristics may be combined in any one or more embodiments or examples in a suitable manner.

The invention is not limited to the above-mentioned optional embodiments. Anyone can come up with various other forms of products under the inspiration of the invention, however, regardless of any changes in its shape or structure. All technical solutions that fall within the scope defined by the claims of the present invention shall fall within the scope of protection of the invention.

1. A roll pick-up truck tonneau cover, comprising a cover, characterized in that the cover comprises:
an intermediate panel with a lay-flat state and a rolled-up state, formed by a plurality of segmented panels rotatably connected, wherein one of the segmented panels can rotate relative to an adjacent segmented panel, and a rotational gap is provided at the transition position between two adjacent segmented panels, wherein at least one edge of each segmented panel is provided with a clamping part;
a plurality of soft layers, arranged in a discontinuous manner, each covering the rotational gap between two adjacent segmented panels to seal the rotational gap;
wherein both sides of each soft layer are connected to the two adjacent clamping parts respectively, ensuring the covered state of the soft layer over the rotational gap.

2. The roll pick-up truck tonneau cover according to claim 1, wherein each segmented panel comprises an upper layer and a lower layer arranged vertically, the upper layer and the lower layer are separated from each other or are constructed as an integral structure, the upper layer is made of metal or plastic, the lower layer is also made of metal or plastic; a fastener is provided between at least two of the three components: the upper layer, the lower layer, and the soft layer.

3. The roll pick-up truck tonneau cover according to claim 2, wherein the segmented panel further comprises:
a protrusion, positioned at the center of the upper layer facing the lower layer (113) or at the center of the lower layer facing the upper layer;
a recess, positioned at the center of the lower layer facing the upper layer or at the center of the upper layer facing the lower layer, wherein the protrusion is matched with the recess to restrict and maintain the relative position between the upper layer and the lower layer.

4. The roll pick-up truck tonneau cover according to claim 2, wherein at least a partial gap is provided at the edge position between the upper layer and the lower layer, one side of the soft layer is clamped into the partial gap at the edge of one segmented panel, while the other side extends over the transition position of the adjacent segmented panel and is clamped into the partial gap at the edge of the adjacent segmented panel, thereby covering the rotational gap between the two adjacent segmented panels.

5. The roll pick-up truck tonneau cover according to claim 4, wherein the clamping part is set within the partial gap and includes:
at least one protrusion, positioned on the side of the upper layer facing the lower layer or on the side of the lower layer facing the upper layer,
at least one indentation, positioned on the side of the lower layer facing the upper layer or on the side of the upper layer facing the lower layer,
wherein the protrusion of the upper layer may or may not correspond to the indentation of the lower layer; or
the indentation of the upper layer may or may not correspond to the protrusion of the lower layer; or
the soft layer may or may not be clamped between the protrusion of the upper layer and the lower layer; or
the soft layer may or may not be clamped between the protrusion of the lower layer and the upper layer.

6. The roll pick-up truck tonneau cover according to claim 1, wherein it further comprises:
a rear panel (13), rotatably connected to one side of the intermediate panel;
a front panel, rotatably connected to the other side of the intermediate panel; and
a guide rail, two guide rails are fixed to the two sides of the pickup truck body by clamps.

7. The roll pick-up truck tonneau cover according to claim 6, wherein:
each segmented panel, front panel, and rear panel has support members installed at both ends, adjacent support members are connected rotationally or non-rotationally, a first Velcro strip is provided on the side of the support member near the guide rail through a first fastener, the first Velcro strip is featured in either a loop or hook surface,
inside the guide rail, a plastic plate is inserted and secured with fasteners, the side of the plastic plate near the support member is provided with a second Velcro strip, featuring either a hook or loop surface,
the first Velcro strip adheres to the second Velcro strip.

8. The roll pick-up truck tonneau cover according to claim 7, wherein the first fastener is a U-shaped staple, the plastic plate is either sewn with or integrally formed with the second Velcro strip.

9. The roll pick-up truck tonneau cover according to claim 7, wherein an elastic strip is provided on the inner side of the guide rail.

10. The roll pick-up truck tonneau cover according to claim 7, wherein:
the plastic plate is provided with a plurality of drainage holes along its length,
a drainage component is installed at the front or rear end of the guide rail, the inlet of the drainage component is connected to the drainage holes, the outlet of the drainage component is connected to a drainage pipe.

11. The roll pick-up truck tonneau cover according to claim 7, wherein it further comprises a sealing strip, which is an elastic component, the bottom surface of the sealing strip is bonded to the upper layer, support member, front panel, or rear panel by glue, and the sealing strip extends through the support member.

12. The roll pick-up truck tonneau cover according to claim 11, wherein the upper layer, lower layer, front panel, or rear panel is provided with screw holes, the contact surface between the support member and the upper layer, lower layer, front panel, or rear panel is sealed with glue to ensure waterproofing, the support member is connected to the upper layer, lower layer, front panel, or rear panel using fasteners.

13. The roll pick-up truck tonneau cover according to claim 11, wherein:
the sealing strip comprises a covering section and a T-shaped section integrally formed with the covering section,
the top of each support member is provided with a clamping slot, the clamping slots of multiple support members are connected in series to form a discontinuous positioning groove,
the T-shaped section is inserted into the positioning groove to ensure that the sealing strip remains in constant contact with the support member, while the covering section covers and seals the gap between the support member and the segmented panel.

14. A roll pick-up truck tonneau cover, comprising a cover, wherein the cover includes:
an intermediate panel with a lay-flat state and a rolled-up state, formed by a plurality of segmented panels rotatably connected, one of the segmented panels can rotate relative to an adjacent segmented panel, and a rotational gap is provided at the transition position between two adjacent segmented panels, at least one edge of each segmented panel is provided with a clamping part,
a plurality of soft layers, arranged in a discontinuous manner, each covering the rotational gap between two adjacent segmented panels to seal the rotational gap,
both sides of each soft layer are connected to the two adjacent clamping parts respectively, ensuring the covered state of the soft layer over the rotational gap,
the clamping part includes at least two accommodating grooves, one of which is provided at the edge of one upper layer or lower layer, while the other is provided at the edge of the adjacent upper layer or lower layer, the two accommodating grooves are arranged opposite each other,
at least two clamping members are positioned and restricted within the two accommodating grooves, one side of the soft layer is fixed to one clamping member, while the other side is fixed to the adjacent clamping member, ensuring that the soft layer covers the rotational gap between two adjacent segmented panels.

15. The roll pick-up truck tonneau cover according to claim 14, wherein the clamping member is a metal strip or plastic strip sewn onto the edge of the soft layer.

16. The roll pick-up truck tonneau cover bed according to claim 14, wherein each segmented panel comprises an upper layer and a lower layer arranged in an upper-lower configuration, the upper layer and the lower layer are separated from each other or are constructed as an integral structure, the upper layer is made of metal or plastic, and the lower layer is made of metal or plastic, at least two of the upper layer, the lower layer, and the soft layer are fastened together by fasteners.

17. The roll pick-up truck tonneau cover according to claim 15, wherein:
the front face of the front panel is connected to a first fixing buckle by fasteners on both sides along its width direction,
the rear face of the front panel is provided with fixing rods positioned on both sides along its width direction, the fixing rods are connected to second fixing buckles through first webbing,
when the cover is in rolled-up state, the second fixing buckle is inserted into and locked with the first fixing buckle, while the first webbing hold and restrict the cover in its rolled-up position.

18. The roll pick-up truck tonneau cover according to claim 15, wherein it further comprises:
a fixing slider slidably connected to the guide rail,
a second fastener, with one end positioned inside a first sliding groove on the back of the front panel, while the other end extending out of the sliding groove, passing through the fixing slider and provided with a locking component,
an anti-loosening component positioned between the locking component and the second fastener.

19. The roll pick-up truck tonneau cover according to claim 18, wherein it further comprises:
a second webbing, with one end provided with a fourth fixing buckle and the other end secured between the second fastener and the locking component,
the front panel is provided with a third fixing buckle installed on both sides along its width direction using fasteners,
the third fixing buckle and the fourth fixing buckle are locked together.

20. The roll pick-up truck tonneau cover according to claim 15, wherein:
the rear panel is provided with extendable and retractable locking latch on both sides along its width direction,
when the locking latch is in the extended state, the rear panel is locked with the guide rail
when the locking latch is in the retracted state, the rear panel is in an unlocked state relative to the guide rail.

21. The roll pick-up truck tonneau cover according to claim 20, wherein it further comprises:
a lock casing, positioned in a groove on the back of the rear panel, the lock casing is provided with a sliding slot, a pull-rod slot, and a wire slot, the sliding slot and the pull-rod slot are interconnected with the wire slot,
a locking latch is slidably connected with the sliding slot,
a pull rod with a rod section and a head section, where the head section is located inside the pull-rod slot, one end of the rod section is connected to the head section, while the other end extends into the sliding slot, is fitted with a spring, and, after passing through the spring, is connected to the locking latch through a pin,
a fixing part is secured above the wire slot by a third fastener, the third fastener is provided with a window through which the webbing is positioned,
a pull wire, which extends into the wire slot, passes through the webbing, and is secured to the head section of the pull rod by a fourth fastener,
when the webbing is pulled in the direction away from the fixing part, the webbing pulls the pull rod towards the direction close to the wire slot, the pull rod, through the pin, drives the locking catch to slide along the slide groove and compresses the spring, causing the spring undergoes elastic deformation, thereby retracting the locking latch.

22. The roll pick-up truck tonneau cover according to claim 21, wherein the back of the cover is provided with at least one elastic component, which is connected to the cover by a fifth fastener, the fifth fastener is embedded in the elastic component.
